(19) United States
(12) Patent Application Publication
(10) Pub. No.: US 2012/0215642 A1
(43) Pub. Date: Aug. 23, 2012

(54) Advertisement Based on Contextual Usage of Application

(76) Inventor: Yoon Kean Wong, Redwood City, CA (US)

(21) Appl. No.: 13/033,290

(22) Filed: Feb. 23, 2011

(51) Int. Cl. G06Q 30/00

(52) U.S. Cl. 705/14.64; 705/14.73

(57) ABSTRACT

A device to detect a contextual usage of an application by a user, transmit data of the contextual usage to a second device, and receive an advertisement based on data of the contextual usage from the second device and output the advertisement on an output component of the device.

### BACKGROUND

When receiving advertisements on a device, a communication component of the device can initially establish a connection to an advertisement service. Once connected, the advertisement service can communicate with the device and select one or more available advertisements to send to the device. Additionally, the advertisement service can access information, such as an age, gender, and/or preference of the user to select custom advertisements for the user. Once an advertisement has been selected, the advertisement service can send the selected advertisement for the device to render for display on a display component of the device.

### BRIEF DESCRIPTION OF THE DRAWINGS

Various features and advantages of the disclosed embodiments will be apparent from the detailed description which follows, taken in conjunction with the accompanying drawings, which together illustrate, by way of example, features of the disclosed embodiments.

FIG. 1 illustrates a device with an input component, an output component, and a transceiver according to an embodiment.

FIG. 2 illustrates a user accessing an application of a device according to an embodiment.

FIG. 3A and FIG. 3B illustrate block diagrams of an usage application identifying data of a contextual usage of an application accessed by a user and transmitting data of the contextual usage to a second device according to embodiments.

FIG. 4 illustrates a block diagram of a second device selecting an advertisement to transmit to a device in response to receiving data of a contextual usage of an application from a device according to an embodiment.

FIG. 5A and FIG. 5B illustrate an output component of a device outputting an advertisement received from a second device according to an embodiment.

FIG. 6 is a flow chart illustrating a method for receiving an advertisement according to an embodiment.

FIG. 7 is a flow chart illustrating a method for receiving an advertisement according to another embodiment.

### DETAILED DESCRIPTION

By detecting a contextual usage of an application by a user of a device, the device can identify how the user is interacting with the application and what the user is using the application for. As a result, the device can accurately identify information from the application which the user is currently interested in, any user information which may be utilized by the application, and/or any additional information which can be utilized by the application.

Additionally, by transmitting data of the contextual usage to a second device, the device can receive an advertisement from the second device based on the data of the contextual usage. The device can then proceed to output the advertisement on an output component of the device. As a result, the user of the device can be exposed to customized and tailored advertisements which can be based on a current activity of the user accessing and/or interacting with the application, information of the user utilized by the application, and/or information of the application.

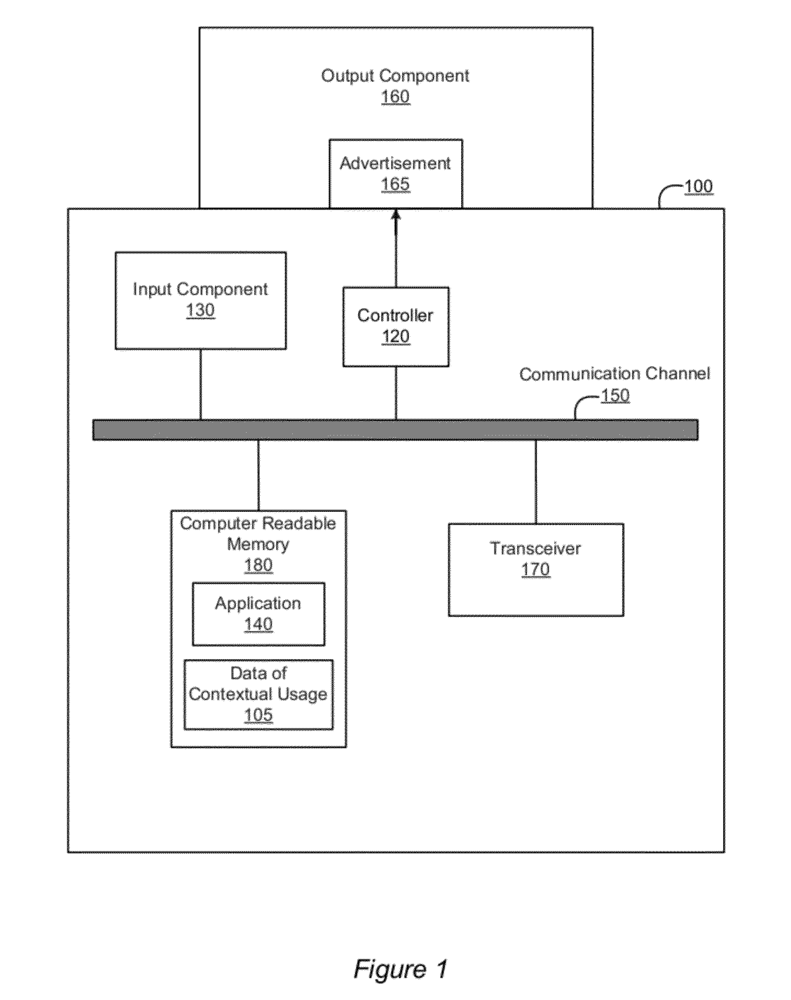

FIG. 1 illustrates a device 100 with an input component 130, an output component 160, and a transceiver 170 according to an embodiment. In one embodiment, the device 100 is or includes a cellular device, a PDA (Personal Digital Assistant), an E (Electronic) Book/Reader and/or the like. In another embodiment, the device 100 is a desktop, a laptop, a notebook, a tablet, a netbook, an all-in-one system, a server, and/or any additional device which can include an input component 130, an output component 160, and a transceiver 170.

As illustrated in FIG. 1, the device 100 includes a controller 120, a an input component 130, an output component 160, a transceiver 170, computer readable memory 180, and a communication channel 150 for the device 100 and/or one or more components of the device 100 to communicate with one another. The computer readable memory 180 can include one or more applications 140. In one embodiment, the device 100 additionally includes a usage application stored on the computer readable memory 180. In other embodiments, the device 100 includes additional components and/or is coupled to additional components in addition to and/or in lieu of those noted above and illustrated in FIG. 1.

As noted above, the device 100 includes a controller 120. The controller 120 can send data and/or instructions to the components of the device 100, such as the input component 130, the output component 160, the transceiver 170, and/or the usage application. The controller 120 can also receive data and/or instructions from components of the device 100, such as the input component 130, the output component 160, the transceiver 170, and/or the usage application.

The usage application is an application which can be utilized in conjunction with the controller 120 to receive an advertisement 165 for the device 100 to output. For the purposes of this application, an advertisement 165 includes media which a transceiver 170 of the device 100 can receive for an output component 160 of the device 100 to output. The media of the advertisement 165 can include information of a product, service, and/or promotion targeting a user of the device 100. In one embodiment, the advertisement 165 includes information or a profile of an entity associated with the advertisement 165.

When receiving an advertisement 165, the controller 120 and/or the usage application can initially detect a contextual usage 105 of an application 140 accessed by a user of the device 100. For the purposes of this application, a contextual usage 105 of an application 140 can be or include a current activity of the user accessing the application 140. The current activity of the user can correspond to content on the application 140 that the user is accessing. In another embodiment, the current activity of the user can include the user entering context information into the application 140. In other embodiments, the contextual usage 105 of the application 140 additionally includes user information and/or metadata of the application 140 which can be utilized by the application 140 accessed by the user.

Using the detected contextual usage of the application 140, the controller 120 and/or the usage application can determine how the application 140 is being used by the user and/or what the user is doing with the application 140. A user can be any person which can access one or more applications 140 on the device 100 with an input component 130 of the device 100. An input component 130 can be a hardware component of the device 100 which the user can utilize to select one or more applications 140 to access. For the purposes of this application, an application 140 can include software and/or firmware accessible to the device 100, which the user of the device 100 can access and/or interact with using the input component 130.

In one embodiment, an application 140 can be or include a multi-functional application, a travel application, a sports application, a news application, a health application, a navigation application, a finance application, a shopping application, an education application, a literature application, a media application, a restaurant application, a gaming application, a searching application, a scheduling application, a social media application, and/or any additional application accessible to the user through the device 100.

In response to detecting the contextual usage 105 of the application, the controller 120 and/or the usage application can proceed to identify data of the contextual usage 105 and transmit the data of the contextual usage 105 to a second device with a transceiver 170 of the device 100. The transceiver 170 is a hardware communication component of the device 100 configured to send and/or receive information and/or data to the second device, such as the contextual usage 105. Additionally, the transceiver 170 can receive one or more advertisements 165 from the second device.

The second device can be a server, a service provider, a desktop, a an all-in-one system, and/or any additional device which can transmit one or more advertisements 165 to the device 100 in response to receiving data of a contextual usage 105 of an application 140 from the device 100. The second device can select one or more advertisements 165 to transmit to the device 100 can be based on the data of the contextual usage 105. In response to receiving an advertisement 165 from the second device, the controller 120 and/or the usage application can proceed to output the advertisement 165 on an output component 160 of the device 100. The output component 160 can be a hardware component of the device 100 configured to display and/or output the advertisement 165 as a visual advertisement and/or an audio advertisement.

The usage application can be firmware which is embedded onto the controller 120, the device 100, and/or the computer readable memory 180 of the device 100. Additionally, the usage application can be an operating system of the device 100. In another embodiment, the usage application can be an application, a service, and/or a thread stored on the device 100 within ROM or on the computer readable memory 180 accessible by the device 100. In other embodiments, the usage application is stored on a storage device and accessible by the device 100 from a different location.

Additionally, in one embodiment, the computer readable memory 180 is included in the device 100. In other embodiments, the computer readable memory 180 is not included in the device 100, but is accessible to the device 100 utilizing a network interface included in the device 100. The network interface can be a wired or wireless network interface card. In other embodiments, the computer readable memory 180 can be configured to couple to one or more ports or interfaces on the device 100 wirelessly or through a wired connection.

In a further embodiment, the usage application is stored and/or accessed through a server coupled through a local area network or a wide area network. The usage application communicates with devices and/or components coupled to the device 100 physically or wirelessly through a communication bus 150 included in or attached to the device 100. In one embodiment the communication bus 150 is a memory bus. In another embodiment, the communication bus 150 is a data bus. In other embodiments, the communication bus 150 can be or include a network interface.

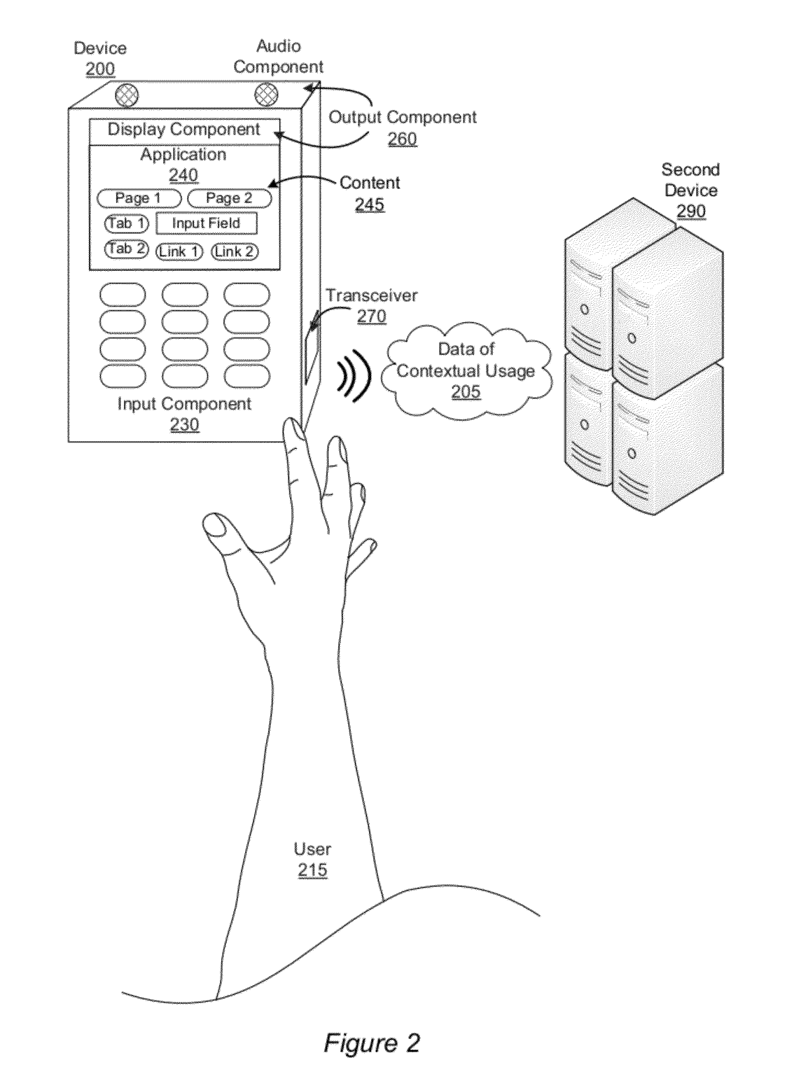

FIG. 2 illustrates a user 215 accessing an application 240 of a device 200 according to an embodiment. As noted above, an application 240 can include software and/or firmware which can be accessed by a user 215 of the device 200. One or more applications 240 can be or include a multi-functional application, a travel application, a sports application, a news application, a health application, a navigation application, a finance application, a shopping application, an education application, a literature application, a media application, a restaurant application, a gaming application, a searching application, a scheduling application, a social media application, and/or any additional application accessible to the device 200.

In one embodiment, one or more application 240 can be locally stored and accessed from a storage device and/or a computer readable memory of the device 200. In another embodiment, one or more application 240 can be remotely stored and/or accessed from a remote location accessible to a transceiver 270 of the device 200. The transceiver 270 can be a hardware component which a controller and/or usage application of the device 200 can utilize to access, send, and/or receive data and/or information. The transceiver 270 can be or include a radio component, a Bluetooth component, an infrared component, a wireless network component, and/or any additional component configured to send and/or receive data and/or information.

The user 215 can initially select one or more local or remote applications 240 to access with an input component 230 of the device 200. As noted above, the input component 230 can be a hardware component of the device 200 configured to detect the user 215 selecting, accessing, and/or interacting with the application 240. In one embodiment, the input component 230 can be or include an alpha numeric keyboard, a mouse, an image capture device, a microphone, a touch device, and/or any additional component configured to detect the user 215 accessing one or more application 240.

In one embodiment, in response to the user selecting an application 240 to access, the accessed application 240 can be outputted on an output component 260 of the device 200. In one embodiment, the output component 260 can be or include a display component coupled to the device 200. The display component can render the application 240 for a display. In another embodiment, the output component 260 can be or include an audio component coupled to the device 200. The audio component can output information of the application 240 as audio. In other embodiments, the output component 260 can be or include any additional component configured to output the application 240 and/or information of the application 240.

As noted above, the user 215 can access and/or interact with the application 240 through the input component 230 of the device 200. When the user 215 is accessing and/or interacting with the application 240, the controller and/or the usage application can detect a contextual usage of the applicable 240. As noted above, a contextual usage 205 of an application 240 can be or include a current activity of the user 215 when accessing the application 240.

In one embodiment, the current activity of the user 215 can correspond to content 245 on the application 240 which the user is accessing. As illustrated in FIG. 2, the content 245 can be or include one or more subpages, one or more feature tabs, one or more links, and/or any additional information, items, and/or objects included in the application 240 which the user 215 can access and/or interact with.

In another embodiment, the current activity of the user 215 can include the user 215 entering context information into the application 240. The context information can include a subject matter, such as an activity item, category, topic, product, location, and/or service the user 215 is interested in. As illustrated in FIG. 2, the application 240 can include one or more input fields. The user 215 can enter context information into one or more of the input fields.

When detecting the contextual usage, the input component 230 can detect the user 215 accessing one or more of the content on the application 240 and/or entering context information into an input field of the application 240. The controller and/or the usage application can then identify which of the content included in the application 240 the user 215 is currently accessing.

In one embodiment, the controller and/or usage application can determine that a corresponding content on the application 240 is being accessed if the user 215 selects, clicks, touches, and/or views the corresponding content for a period of time. The controller and/or the usage application can access metadata of the application 240 and/or information of the tab, subpage, and/or link to determine whether it was accessed. In another embodiment, the controller and/or the usage application can access location information from the input component 230 to determine where on the application 240 the user is accessing to determine which of the components the user is accessing. Additionally, the controller and/or the usage application can identify what data and/or information is included in the context information entered into the input field by the user 215.

In another embodiment, a contextual usage of the application 240 includes predefined user information which can be utilized by the application 240. When detecting the contextual usage, the controller and/or the usage application can detect what user information is being accessed and/or utilized by the application 240. In other embodiments, the contextual usage includes metadata of the application 240 which can be utilized by the application 240. When detecting the contextual usage, the controller and/or the usage application can access the metadata to identify any data and/or information associated with the application 240.

In response to detecting a contextual usage of the application 240, the controller and/or the usage application can identify data of the contextual usage 205 and proceed to transmit the data of the contextual usage 205 to a second device 290. In one embodiment, information of any content of the application 240 accessed by the user 215, any context information entered by the user 215, any user information utilized by the application 240, and/or any metadata utilized by the application 240 is aggregated as the data of the contextual usage 205.

As noted above, the transceiver 270 of the device 200 can be utilized to transmit the data of the contextual usage 205. When transmitting the data of the contextual usage 205, the transceiver 270 can transmit the data as a file, a text message, an SMS (short message service) message, a MMS (multimedia messaging service) message, an email, a voice message, a video message, a JavaScript Object Notation (JSON) message, a simple object access protocol (SOAP) message, an extensible markup language (XML)—formatted query, and/or any other form of signal, file, message.

As noted above, the second device 290 can be a server, a service provider, a desktop, an all-in-one system, and/or any additional device which can transmit one or more advertisements to the transceiver 270 of the device 200 based on the data of the contextual usage 205 received from the device 200.

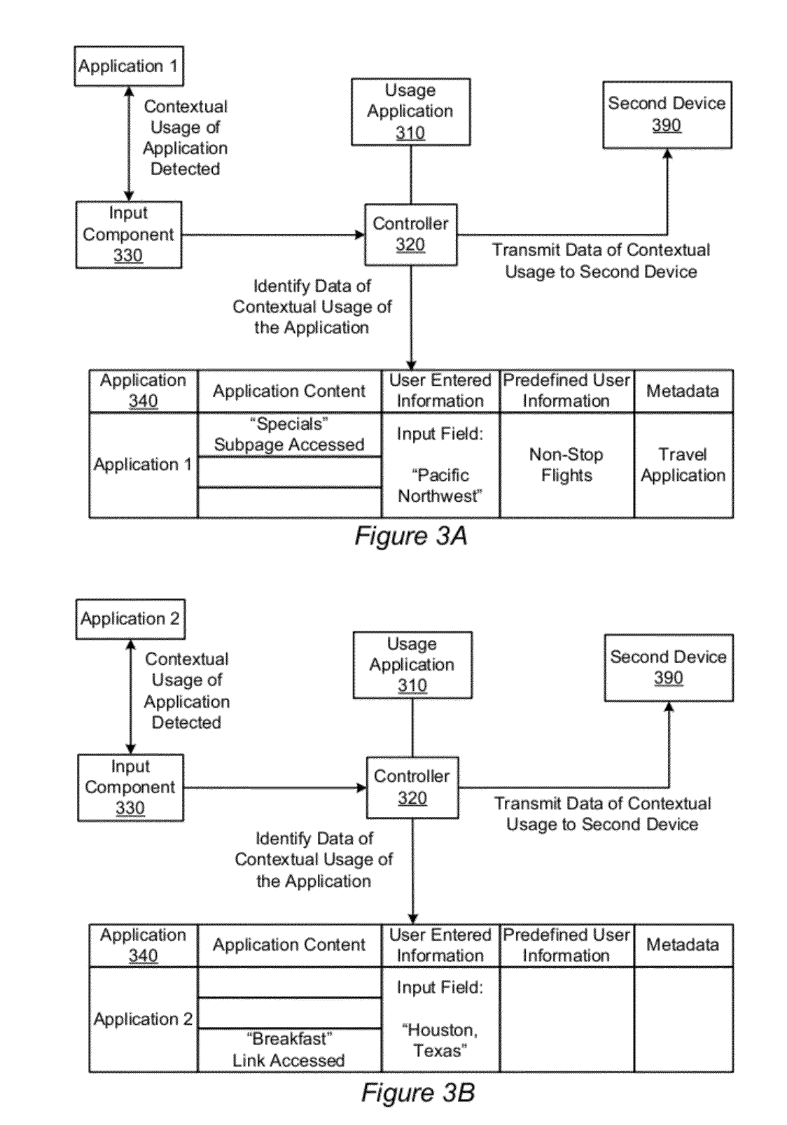

FIG. 3A and FIG. 3B illustrate block diagrams of a usage application 310 identifying data of a contextual usage of an application accessed by a user and transmitting the data to a second device 390 according to embodiments. As noted above, in response to a user accessing and/or interacting with an application 340, the controller 320 and/or the usage application 310 can detect a contextual usage of the application 340 and identify data of the contextual usage.

In one embodiment, the data of the contextual usage can include a user activity of the user, predefined user information, and/or information of the application. As shown in FIG. 3A, the input component 330 has detected the user accessing and/or interacting with Application 1. The input component 330 has detected the user to be accessing and/or interacting with content, a subpage, on Application 1. Additionally, the input component 330 has detected the user entering context information into an input field of Application 1. As a result, the input component 330 has detected a user activity of the user accessing Application 1.

The controller 320 and/or the usage application 310 proceed to identify data of the contextual usage. As illustrated in FIG. 3A, the controller 320 and/or the usage application 310 can access information detected from the input component 330 to identify an activity of the user. The controller 320 and/or the usage application 310 identify that the accessed subpage has been marked as “Specials.” Additionally, the controller 320 and/or the usage application identify that the user entered a text string “Pacific Northwest.”

Further, the controller 320 and/or the usage application 310 have determined that Application 1 is accessing predefined user information associated with the user. As shown in FIG. 3A, the predefined user information lists that the user prefers “non-stop flights.” In another embodiment, the predefined user information can be a profile of the user created by the user, the controller 320 and/or the usage application 310. Additionally, the controller 320 and/or the usage application 310 also determine that a metadata of Application 1 includes information of Application 1. In one embodiment, the information of an application included in the metadata can be or include a genre of the application.

A genre of the application can include information about a theme of the application and/or about the type of content included in the application. The genre can be or include travel, sports, news, health, navigation, finance, application, education, literature, media, restaurant, food, games, searching, social media, and/or any additional genre. As shown in FIG. 3A, the metadata lists that a genre of Application 1 is Travel.

As a result, the controller 320 and/or the usage application 310 determine that the data of the contextual usage includes the user activity, “Specials” and “Pacific Northwest,” predefined user information of preferring Non-Stop Flights, and metadata listing a genre of Application 1 to be travel. The controller 320 and/or the usage application 310 then aggregate the information and transmit the data of the contextual usage to the second device 390. As noted above, the data of the contextual usage can be sent as a file, a text message, an SMS (short message service) message, a MMS (multimedia messaging service) message, an email, a voice message, a video message, a JSON message, a SOAP message, an XML—formatted query, and/or any other form of signal, file, message.

In another embodiment, the data of the contextual usage includes a user activity of the user accessing an application 340, without any predefined user information or application information. As shown in FIG. 3B, the input component 330 has detected information of a contextual usage of Application 2. In response, the controller 320 and/or the usage application 310 access the information from the input component 330 and determine that the contextual usage of Application 2 includes the user accessing content on Application 2 and entering context information into an input field of Application 2.

As shown in FIG. 3B, the controller 320 and/or the usage application 310 have determined that the user is accessing a link for “Breakfast” within Application 2. Additionally, the controller 320 and/or the usage application 310 have determined that the user has entered the context information “Houston, Tex.” Further, the controller 320 and/or the usage application 310 determine that no predefined user information is being accessed by Application 2 and Application 2 does not include any metadata listing information of Application 2.

As a result, the controller 320 and/or the usage application 310 include the user activity of accessing the “Breakfast” content of Application 2 and entering context information “Houston, Tex.” as data of the contextual usage. The controller 320 and/or the usage application 310 then transmit the data of the contextual usage to the second device 390. In other embodiments, the controller 320 and/or the usage application 310 can identify data of the contextual usage using additional methods in addition to and/or in lieu of those noted above.

In one embodiment, the user can modify one or more privacy settings on the application and/or on the device to control and/or restrict what form of information can be included in the data of the contextual usage. Before transmitting the data of the contextual usage to the second device 390, the controller 320 and/or the usage application 310 can check one or more of the privacy settings before transmitting the data of the contextual usage.

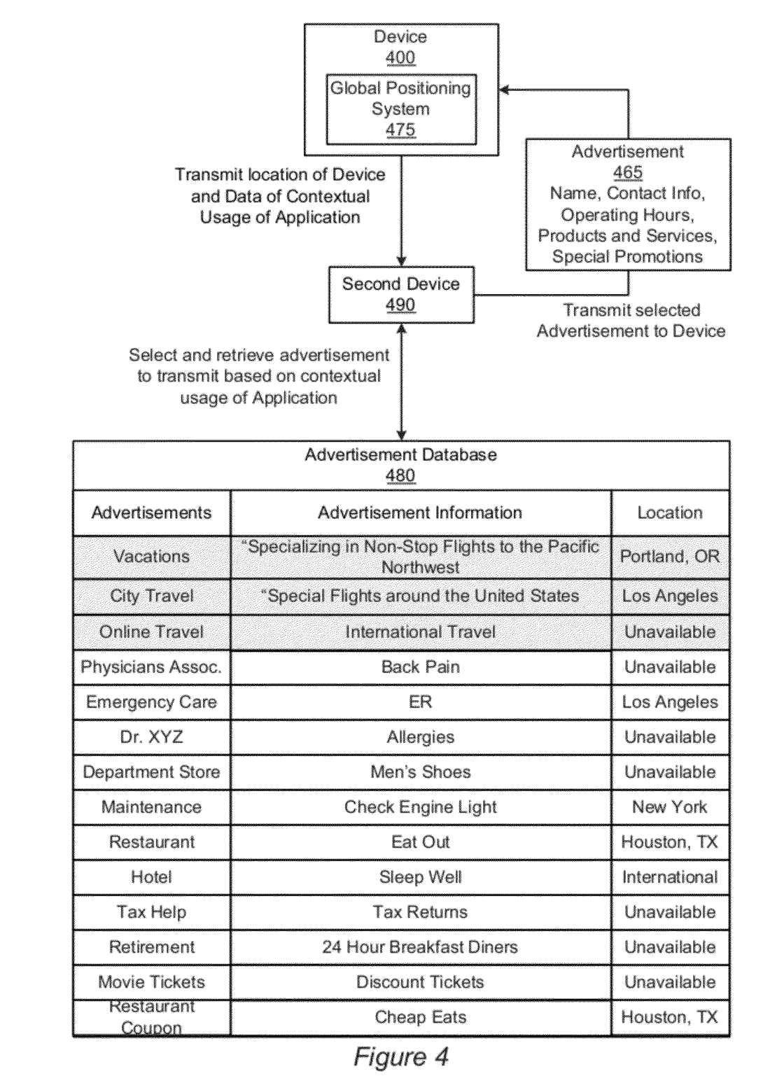

FIG. 4 illustrates a block diagram of a second device 490 selecting an advertisement 465 to transmit to a device 400 in response to receiving data of a contextual usage of an application according to an embodiment. As shown in the present embodiment, the device 400 can also include a global positioning system 475. The global positioning system can be a hardware component of the device 400 configured to detect and/or identify a location of the device 400. In one embodiment, the location of the device 400 can also be sent to the second device 490 in addition to the data of the contextual usage of the application.

As shown in FIG. 4, in response to receiving the data of the contextual usage and/or a location of the device 400, the second device 490 proceeds to select and retrieve one or more advertisements 465 to transmit to the device 400 based on the received data. In one embodiment, the second device 490 can access an advertisement database 480 when selecting one or more advertisements 465 based on the received data. The advertisement database 480 can be stored on the second device 490 or the advertisement database 480 can be stored on a service provider accessible to the second device 490. The service provider can be or include an advertising service.

As shown in the present embodiment, the advertisement database 480 can include one or more entries, each with an advertisement 465, information associated with the advertisement 465, and/or a target location for the advertisement 465. In one embodiment, one or more of the advertisements 465 can be temporal and one or more of the entries can also specify a time which a corresponding advertisement can be active or inactive. An advertisement 465 can have a corresponding time which the advertisement can be transmitted and/or a corresponding time which the advertisement 465 cannot be transmitted.

When determining which of the advertisements 465 to select and transmit to the device 400, the second device 490 can compare information from the data of the contextual usage to advertisement information included in the entries of the advertisement database 480. If the second device 490 determines that one or more of the entries include advertisement information which matches one or more of the information from the data, the second device 490 will determine that the corresponding advertisement 465 includes information which the user of the device could be interested in.

The second device 490 can then proceed to transmit the corresponding advertisement 465 to the device 400. In one embodiment, the second device 490 can also prioritize advertisements 465 which include advertisement information which matches all or a majority of the information from the data. In another embodiment, the second device 490 can further prioritize advertisements 465 with a target location around the location of the device 400. In other embodiments, the second device 490 can additionally prioritize advertisements 465 with content or formatting which is targeting and/or optimized for one or more output components of the device 400. Further, one or more of the advertisements 465 can be sent one by one by the second device 490. In another embodiment, the second device 490 can aggregate advertisements 465 based on their priority level and send the advertisements 465 with matching priority levels in a package of advertisements 465 to the device 400.

In one embodiment, the second device 490 has received data of the contextual usage of the application and a location of the device 400. The second device determines that the information from the data lists that the user is looking for “Specials” for the “Pacific Northwest.” Additionally, the information includes that the user prefers “Non-Stop Flights” a genre of the application accessed by the user was a travel application. Further, the location of the device 400 is identified to be Portland, Oreg.

In response, the second device 490 proceeds to access advertisement information entries in the advertisement database 480 and searches the entries for advertisement information that matches information from the data of contextual usage. As illustrated in FIG. 4, the second device 490 has found 3 advertisements (Vacations, City Travel, and Online Travel) which include advertisement information which matches one or more of the data of the contextual usage. Additionally, because the first advertisement (Vacations) includes advertisement information which matches all or most of the information of the data and the advertisement's target location is Portland, Oreg., the second device prioritizes the Vacations advertisement and transmits the Vacations advertisement before any of the other two advertisements.

In one embodiment, the advertisement 465 transmitted can include media of the advertisement 465. The media can include information of a product, a service, a brand, a personal and/or a promotion targeting a user of the device 400. As illustrated in the present embodiment, the advertisement 465 can also include a profile of an entity associated with the advertisement 465. The profile of the entity can include a name of the entity, a contact information of the entity, an operating hours of the entity, a product offered by the entity, a service offered by the entity, and/or a special promotion offered by the entity.

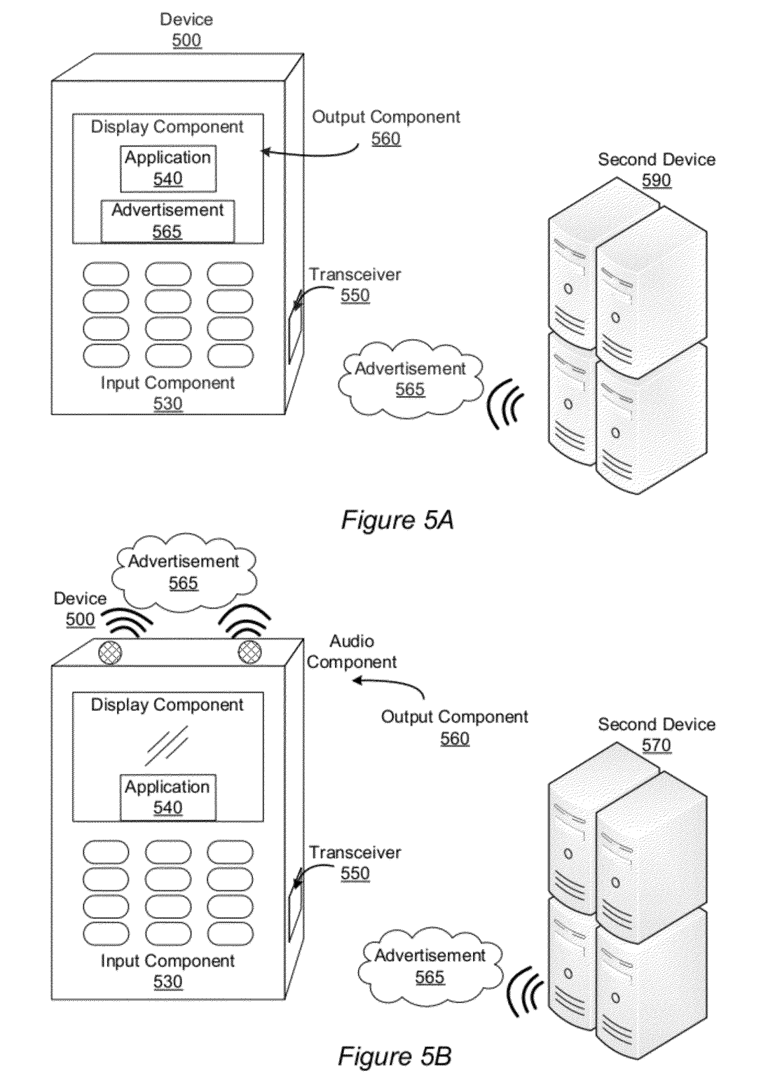

FIG. 5A and FIG. 5B illustrate an output component 560 of a device 500 outputting an advertisement 565 received from a second device 590 according to an embodiment. The advertisement 565 can be based on data of a contextual usage of the application 540. Additionally, the advertisement 565 can be received by a transceiver 570 of the device 500 from the second device 590 as a file, a text message, an SMS message, a MMS message, an email, a voice message, a video message, a JSON message, a SOAP query, an XML—formatted query, and/or any other form of signal, file, or message.

In response to receiving an advertisement 565, a controller and/or a usage application of the device 500 can output the advertisement 565 on an output component 560 coupled to the device 500. In one embodiment, if more than one advertisement 565 is received from the second device 590, the controller and/or usage application of the device 500 can identify a priority of one or more of the advertisements and proceed to output the advertisements based on their priority.

As noted above, a priority of an advertisement 565 can be based on a corresponding advertisement 565 including all or a majority of the information from the data of the contextual usage of the application 540, a corresponding advertisement 565 with a target location around the location of the device 500, and/or a corresponding advertisement 565 including content or formatting which is targeting and/or optimized for one or more output components of the device 500. The controller and/or the usage application can identify a priority of an advertisement 565 based on an order of advertisements 565 received from the second device 590 and/or by comparing the data of the contextual usage to information included in a received advertisement 565.

When outputting the advertisement 565, the controller and/or the usage application can output a product, a service, a promotion, and/or a profile of an entity associated with the advertisement 565. As shown in FIG. 5A, the output component 560 can be a display component coupled to the device 500. As noted above, the display component can be a hardware component of the device 500 configured to display one or more advertisements 565 for a user of the device 500 to view. The display component can include a LCD (liquid crystal display), a LED (light emitting diode) display, a CRT (cathode ray tube) display, a plasma display, a projector, a touch wall and/or any additional device configured to output an advertisement 565.

The advertisement 565 can be displayed on one or more locations of the display component. In one embodiment, the advertisement 565 can be rendered on a portion of the display component which overlaps the application 540. In another embodiment, the advertisement 565 can be rendered on a portion of the display component which does not overlap the application 540. In other embodiments, the advertisement 565 can be rendered as part of the application 565 or on a portion of the display component which the application 540 can control.

Additionally, the advertisement 565 can include media and/or a profile of an entity associated with the advertisement. The controller and/or the usage application of the device 500 can access data and/or information included in the advertisement 565 to render the data and/or information as media on the display component. When rendering the advertisement 565, the advertisement can be rendered as an image, a video, text, a message and/or a hyperlink for the user to view and/or interact with.

In another embodiment, as illustrated in FIG. 5B, an advertisement 565 received from the second device 590 can be outputted as audio through the output component 560 of the device 500. As noted above, the output component 560 can be or include an audio component configured by the controller and/or the usage application to output the advertisement 565 as an audio advertisement. The audio component can be or include one or more audio speakers, a distribution system, and/or a transducer. In another embodiment, the output component 560 can include an actuator or a motor configured to output an advertisement 565 by generating feedback which can be felt by the user. In other embodiments, the output component 560 can be or include any additional component configured to output an advertisement 565 which can be viewed, felt, and/or perceived by the user in addition to and/or in lieu of those noted.

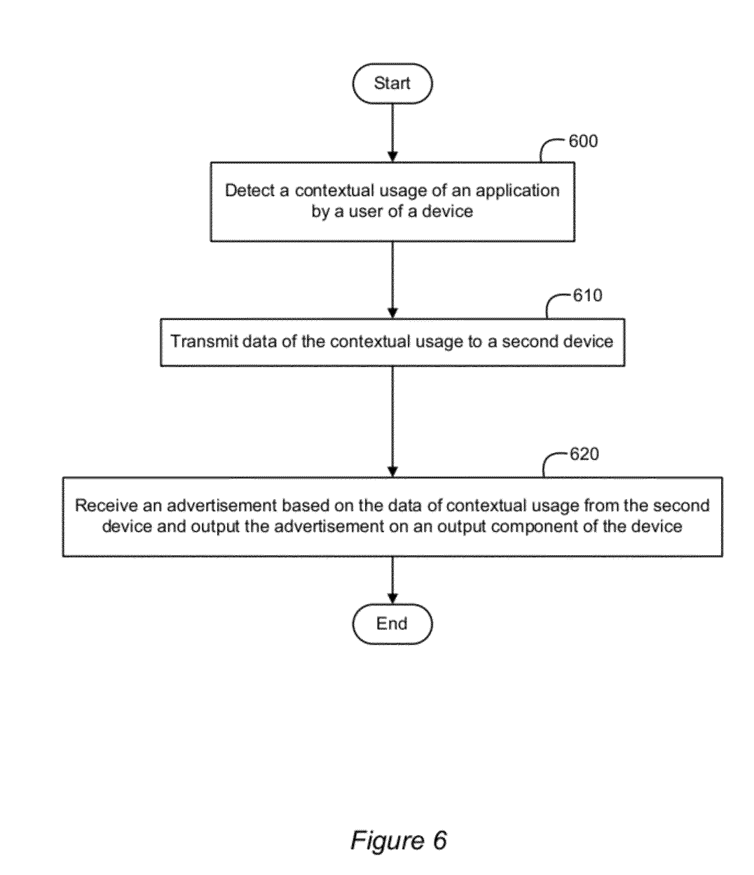

FIG. 6 is a flow chart illustrating a method for receiving an advertisement according to an embodiment. The method of FIG. 6 uses a device with a controller, an input component, an output component, a transceiver, a communication channel, and/or a usage application. In other embodiments, the method of FIG. 6 uses additional components and/or devices in addition to and/or in lieu of those noted above and illustrated in FIGS. 1, 2, 3, 4, and 5.

As noted above, the usage application is an application which can be used in conjunction with the controller to receive an advertisement from a second device and output the advertisement on the output component. As noted above, the second device can be a server, a service provider, a desktop, an all-in-one system, and/or any additional device which can transmit one or more advertisements to the device in response to receiving data of a contextual usage of an application from the device.

The contextual usage corresponds to a current activity of the user when accessing the application, predefined user information utilized by the application, and/or any additional information of the application included in and/or inferred by metadata of the application. Using the contextual usage, the controller and/or the usage application can determine how a user is interacting with the application and what the user is doing with the application.

The controller and/or the usage application can initially use the input component to detect contextual usage by the user of the device 600. As noted above, when detecting the contextual usage, the input component can detect the user accessing and/or interacting with content included in the application. In one embodiment, the user can be detected to be accessing and/or interacting with the content if the input component detects the user selecting, clicking, hovering, and/or viewing for an extended time the content on the application.

In another embodiment, when detecting the contextual usage, the input component can detect the user entering context information into an input field of the application. In other embodiments, when detecting the contextual usage, the controller and/or the usage application can determine whether the application is accessing predefined user information or if the application includes information in the metadata.

In response to detecting the contextual usage of the application, the controller and/or the usage application can transmit data of the contextual usage to the second device 610. As noted above, the data includes information of the contextual usage previously detected by the input component, the controller, and/or the usage application. Additionally, when transmitting data of the contextual usage, the transceiver of the device can send the data as a file, a text message, an SMS message, a MMS message, an email, a voice message, a video message, a JSON message, a SOAP query, an XML—formatted query, and/or any other form of signal, file, or message.

As noted above, the second device can select one or more advertisements to transmit back to the transceiver of the device based on the data of the contextual usage of the application. In one embodiment, the second device can compare the received data to advertisement information to determine whether a corresponding advertisement matches one or more terms, text, and/or conditions of the data. If a match is found, the second device will determine that the matching advertisement includes information which the user of the device is interested in. The second device will then proceed to transmit the matching advertisement to the transceiver of the device.

As noted above, the advertisement can include media of a product, service, and/or promotion. Additionally, the advertisement can include a profile of an entity associated with the advertisement. In response to receiving an advertisement based on the data of the contextual usage from the second device, the controller and/or the usage application can proceed to output the advertisement on an output component of the device 620.

As noted above, the output component is a hardware component of the device configured to output the advertisement as a visual advertisement and/or an audio advertisement. In one embodiment, the output component can be a display component. In another embodiment, the output component can be an audio component. The method is then complete. In other embodiments, the method of FIG. 6 includes additional steps in addition to and/or in lieu of those depicted in FIG. 6.

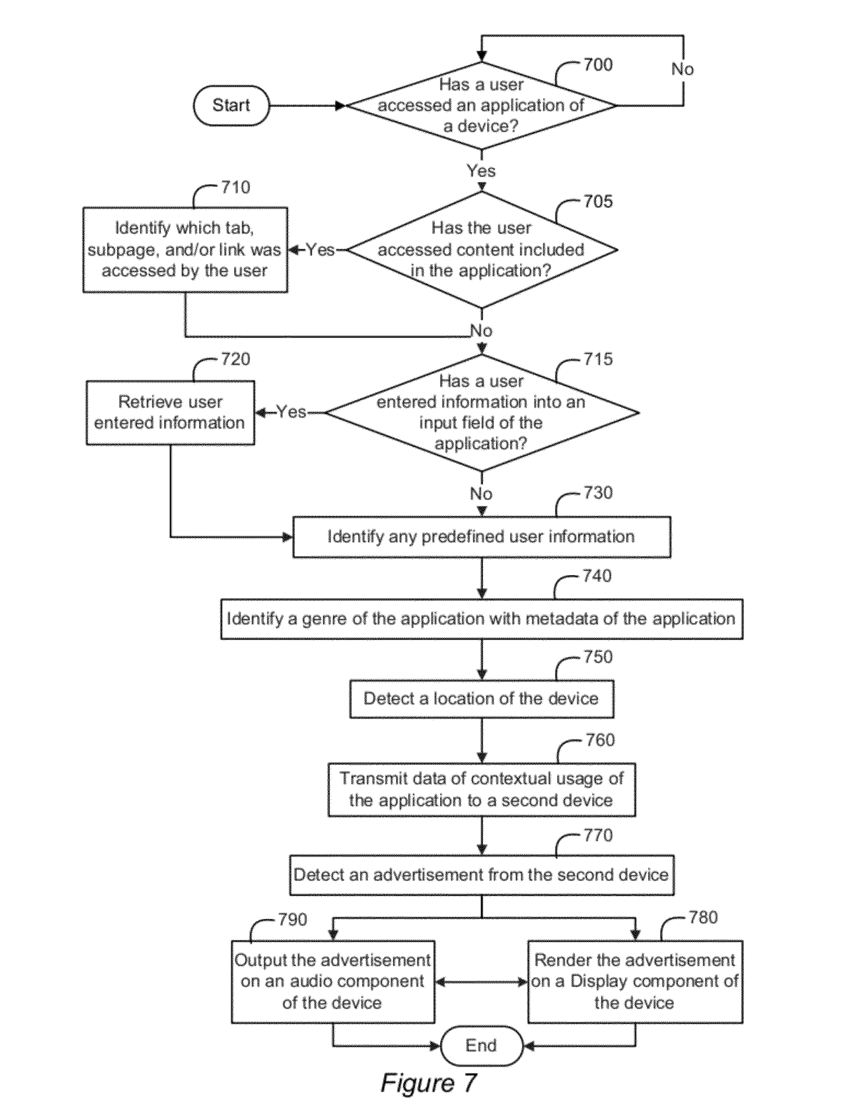

FIG. 7 is a flow chart illustrating a method for receiving an advertisement according to another embodiment. Similar to above, the method of FIG. 7 uses a device with a controller, an input component, an output component, a transceiver, a communication channel, and/or a usage application. In other embodiments, the method of FIG. 7 uses additional components and/or devices in addition to and/or in lieu of those noted above and illustrated in FIGS. 1, 2, 3, 4, and 5.

The controller and/or the usage application can initially determine whether a user has accessed an application of a device 700. As noted above, a user can select one or more applications to access and/or interact with using the input component of the device. If the input component does not detect the user accessing any applications, the input component can continue to detect the user accessing an application on the device 700.

If the input component detects the user accessing an application, the controller and/or the usage application can proceed to detect contextual usage of the application by the user. As noted above, when detecting the contextual usage, the input component can detect whether the user has accessed content included in the application 705. The content can be or include a feature tab, a subpage, and/or a link in the application.

As noted above, the user can access content on the application with the input component by selecting, clicking, hovering over, and/or continuing to view the content for a period of time. If the user is detected to be accessing content on the application, the controller and/or the usage application can proceed to identify which feature tab, subpage, and/or link was accessed by the user 710. The controller and/or the usage application can access information of the feature tab, subpage, and/or link to determine whether it was accessed. In another embodiment, the controller and/or the usage application can identify a location of where on the application the user is accessing to determine which of the components the user is accessing.

In another embodiment, if the user is not detected to be accessing any content on the application, the controller and/or the usage application can proceed to determine whether the user has entered context information into an input field of the application 715. If the input component detects the user entering any context information into an input field, the controller and/or the usage application can identify and retrieve the entered context information 720. The controller and/or the usage application can then proceed to identify any predefined user information 730.

If no context information was previously detected to be inputted, the controller and/or the usage application can skip identifying context information and proceed to identify any predefined user information 730. As noted above, the predefined user information can include a user profile created from the user, the controller, and/or the usage application. Additionally, the controller and/or the usage application can access metadata of the application to determine whether a genre of the application is listed 740. As noted above, a genre of the application can include information about a theme of the application and/or about the type of content included in the application.

Using one or more of the information identified from the user accessing content on the application, the user entering context information into the application, detecting predefined user information utilized by the application, and/or identifying a genre of the application, the controller and/or the usage application include and/or populate the above information into a data of the contextual usage of the application. In one embodiment, as noted above, the device can include a global positioning system which can detect and/or identify a location of the device 750.

The controller and/or the usage application can then transmit the data of the contextual usage and/or the location of the device over to a second device through the transceiver 760. The transceiver can then detect one or more advertisements from the second device 770. As noted above, the second device can access an advertisement database of one or more advertisements. In one embodiment, the advertisement database can be included in the second device. In another embodiment, the advertising database can be included in a service provider, such as an advertising service, accessible to the second device.

Using the data of the contextual usage, the second device can identify advertisements which include advertising information which match the information included in the data of the contextual usage. The second device can then transmit to the device any matching advertisements which include information the user may be interested in based on the contextual usage of the application by the user.

In response to receiving one or more advertisements, the controller and/or the usage application can proceed to output the advertisement on one or more output components of the device. In one embodiment, the output component includes a display component configured to render and/or display the advertisement as an image, video, and/or message 780. In another embodiment, the output component includes an audio component configured to output the advertisement as an audio advertisement 790. The method is then complete. In other embodiments, the method of FIG. 7 includes additional steps in addition to and/or in lieu of those depicted in FIG. 7.

What is claimed is:

1. A method for receiving an advertisement comprising:
detecting a contextual usage of an application by a user of a device;
transmitting data of the contextual usage to a second device; and
receiving an advertisement based on the data of contextual usage from the second device and outputting the advertisement on an output component of the device.

2. The method for receiving an advertisement of claim 1 wherein detecting the contextual usage of the application includes detecting a current activity of the user if the user is accessing the application.

3. The method for receiving an advertisement of claim 2 wherein detecting the current activity of the user includes detecting the user accessing at least one of a feature tab included in the application, a subpage included in the application, and a link included in the application.

4. The method for receiving an advertisement of claim 2 wherein detecting the current activity of the user includes detecting context information input by the user into an input field of the application.

5. The method for receiving an advertisement of claim 1 wherein detecting the contextual usage includes identifying user information utilized by the application.

6. The method for receiving an advertisement of claim 1 wherein detecting the contextual usage includes identifying metadata utilized by the application.

7. The method for receiving an advertisement of claim 6 wherein the metadata can identify a genre of the application to include at least one of multi-function, travel, sports, news, health, navigation, finance, shopping, education, literature, media, restaurant, food, scheduling, gaming, searching, and social utility.

8. The method for receiving an advertisement of claim 1 wherein outputting the advertisement includes identifying a priority of one or more advertisements received from the second device and outputting the advertisements on the output component based on the priority.

9. The method for receiving an advertisement of claim 1 wherein outputting the advertisement includes outputting the advertisement as audio through an audio component coupled to the device.

10. A device comprising:
an input component to detect a user accessing an application of the device;
a controller to identify data of a contextual usage of the application by the user;
a transceiver to transmit the data of the contextual usage to a second device and receive an advertisement based on the data of the contextual usage; and
an output component to output the advertisement received from the second device.

11. The device of claim 10 wherein the second device selects an advertisement from an advertisement database to transmit to the device based on the data of the contextual usage of the application.

12. The device of claim 11 wherein the second device prioritizes an advertisement from the advertisement database which includes advertisement information which matches at least one of all of the information from the data of the contextual usage and a majority of the information from the data of the contextual usage.

13. The device of claim 10 further comprising a global positioning system to detect a location of the device for the transceiver to transmit to the second device.

14. The device of claim 13 wherein the second device selects an advertisement from an advertisement database from an entity within proximity of the location of the device to transmit to the device.

15. The device of claim 10 wherein the output component includes a display component to render the advertisement as at least one of an image, a video, a message, and a hyperlink.

16. The device of claim 15 wherein the display component renders the advertisement on a portion of the display component which overlaps the application.

17. The device of claim 10 wherein the input component includes at least one of a keyboard, a mouse, an image capture device, a microphone, and a touch device.

18. A computer readable medium comprising instructions that if executed cause a controller to:
detect a contextual usage of an application by a user of a device and identify data of the contextual usage;
transmit the data of the contextual usage to a second device and receive an advertisement based on the data of the contextual usage from the second device; and
output the advertisement on an output component of the device.

19. The computer readable medium comprising instructions of claim 18 wherein the advertisement includes a profile of an entity associated with the advertisement.

20. The computer readable medium comprising instructions of claim 19 wherein the profile of the entity includes at least one of a name of the entity, a contact information of the entity, an operating hours of the entity, a product offered by the entity, a service offered by the entity, and a special promotion offered by the entity.
